(19) United States
(12) Patent Application Publication
(10) Pub. No.: US 2026/0147997 A1
(43) Pub. Date: May 28, 2026

(54) COMPUTER PROGRAM PRODUCT, INFORMATION PROCESSING APPARATUS, AND INFORMATION PROCESSING METHOD

(71) Applicant: KABUSHIKI KAISHA TOSHIBA, Tokyo (JP)

(72) Inventors: Atsushi KAWASAKI, Yokohama (JP); Hisayoshi NAGAE, Yokohama (JP); Tsuyoshi KUSHIMA, Chigasaki (JP); Qingxiuxiong DONG, Koto (JP); Tomoki WATANABE, Inagi (JP)

(73) Assignee: KABUSHIKI KAISHA TOSHIBA, Tokyo (JP)

(21) Appl. No.: 19/256,462

(22) Filed: Jul. 1, 2025

(30) Foreign Application Priority Data
Nov. 27, 2024 (JP) 2024-206029

(51) Int. Cl. G06F 40/279; G06F 16/353; G06F 21/64

(52) U.S. Cl. CPC G06F 40/279; G06F 16/353; G06F 21/64

(57) ABSTRACT

According to an embodiment, a computer program product causes a computer to perform: acquiring a generation request for generation of an execution procedure for a process, the generation request being described in natural language; using the generation request and a first verification item for verifying reference information for reference in generating the execution procedure, generating a second verification item other than the first verification item; identifying missing information indicating the reference information not obtained from the generation request, in the reference information to be verified based on the first verification item and the second verification item; acquiring the identified missing information, from an information source other than the generation request; and generating the execution procedure based on an element selected from an element determined in advance for the execution procedure, using the generation request, the reference information obtained from the generation request, and the acquired missing information.

### CROSS-REFERENCE TO RELATED APPLICATIONS

This application is based upon and claims the benefit of priority from Japanese Patent Application No. 2024-206029, filed on Nov. 27, 2024; the entire contents of which are incorporated herein by reference.

### FIELD

Embodiments described herein relate generally to a computer program product, an information processing apparatus, and an information processing method.

### BACKGROUND

Due to the progress of artificial intelligence (AI) technology, the application of language models, such as a large language model (LLM), has been rapidly widespread in the field of natural language processing (NLP). Such a language model corresponds to a model to be trained using an enormous data set and is capable of understanding and generating human language. In particular, in task planning in which previously prepared processes (works) are combined based on a request from a user and an execution procedure for a process for achieving the request is generated, practical use of a language model enables automation and enhanced efficiency of generation of a complicated execution procedure.

Note that a conventional task planning technique with no language model mainly depends on a rule-based approach and thus may lack flexibility and adaptability. Against this, language models are outstanding as new means for achieving flexible task planning with natural language.

### BRIEF DESCRIPTION OF THE DRAWINGS

FIG. 1 is a block diagram of an information processing apparatus according to an embodiment;

FIG. 2 illustrates exemplary element information that a storage unit stores;

FIG. 3 is a flowchart of a procedure generation process in the embodiment;

FIG. 4 is a flowchart of a verification-item generation process in the embodiment;

FIG. 5 is a flowchart of a verification-item generation process in the embodiment;

FIG. 6 is a flowchart of a verification-item generation process in the embodiment;

FIG. 7 illustrates an exemplary user interface;

FIG. 8 illustrates an exemplary user interface;

FIG. 9 illustrates an exemplary verification screen for verifying reference information; and

FIG. 10 is a hardware configuration diagram of the information processing apparatus according to the embodiment.

### DETAILED DESCRIPTION

According to an embodiment, a computer program product includes a non-transitory computer-readable medium including programmed instructions. The instructions causes a computer to perform: acquiring a generation request for generation of an execution procedure for at least one process, the generation request being described in natural language; using the generation request and at least one first verification item determined in advance, generating at least one second verification item, the at least one first verification item serving as a verification item for verifying reference information for reference in generating the execution procedure, the at least one second verification item being the verification item other than the at least one first verification item; identifying at least one piece of missing information indicating the reference information not obtained from the generation request, in the reference information to be verified based on the at least one first verification item and the at least one second verification item; acquiring the at least one piece of identified missing information, from an information source other than the generation request; and selecting, from at least one element determined in advance for the execution procedure, at least one element using the generation request, the reference information obtained from the generation request, and the at least one piece of acquired missing information, and generating the execution procedure based on the at least one selected element.

Preferred embodiments of an information processing apparatus according to the invention will be described in detail below with reference to the accompanying drawings.

In task planning, in a case where a user's request described in natural language lacks information necessary for generation of an execution procedure, the execution procedure may fail to be generated accurately. For example, in a case where a sentence of a request input by a user has ambiguity, an execution procedure may fail to be generated accurately.

According to a configuration in which a language model estimates missing information and generates an execution procedure, if wrong information is estimated, a desired execution procedure may fail to be obtained. In order to solve such a problem, a technique called slot filling has been developed. Slot filling is a technique in which particular slots (verification items) are set in advance, slots are made filled based on a user's request, and an inquiry or the like is made about unfilled information to collect in advance information necessary for achieving an execution procedure.

According to such a technique as slot filling, in a case where various execution procedures are requested, verification items are difficult to set comprehensively. For example, in a case where components in image recognition software created in the past are combined to generate new software (exemplary execution procedure), for user's various requests, all slots for inquiry are difficult to prepare in advance.

An information processing apparatus according to an embodiment serves as an apparatus that generates an execution procedure for at least one process for achieving a user's request and collects in advance missing information for generation of the execution procedure. For example, the information processing apparatus according to the embodiment is capable of generating verification items (slots) with no omission in response to user's various requests. Thus, no missing information is present for generation of an execution procedure, leading to an improvement in the accuracy of task planning.

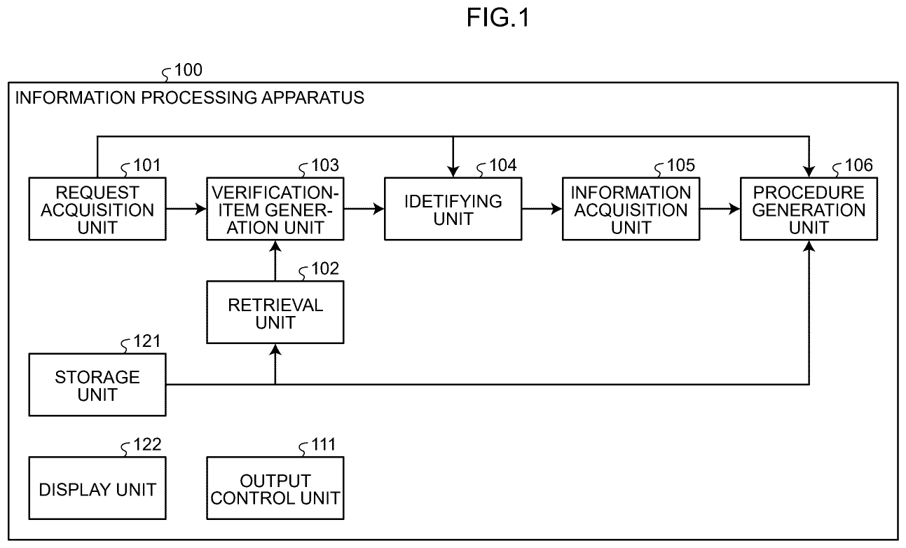

FIG. 1 is a block diagram illustrating an exemplary configuration of an information processing apparatus 100 according to an embodiment. As illustrated in FIG. 1, the information processing apparatus 100 includes a request acquisition unit 101, a retrieval unit 102, a verification-item generation unit 103, an identifying unit 104, an information acquisition unit 105, a procedure generation unit 106, an output control unit 111, a storage unit 121, and a display unit 122.

The storage unit 121 stores various types of information for use in the information processing apparatus 100. For example, the storage unit 121 stores in advance at least one piece of element information (operation information) indicating an element for an execution procedure. Such element information may be any form of information, and examples thereof include the following pieces of information:
Application programming interface (API) information on software components or hardware components: the API information includes, for example, a description (explanatory note) corresponding to an argument (input), a function, and a return value (output).

Procedure information indicating each procedure in a manual, such as an operation manual or a troubleshooting manual: the procedure information includes, for example, the description of a specific procedure.

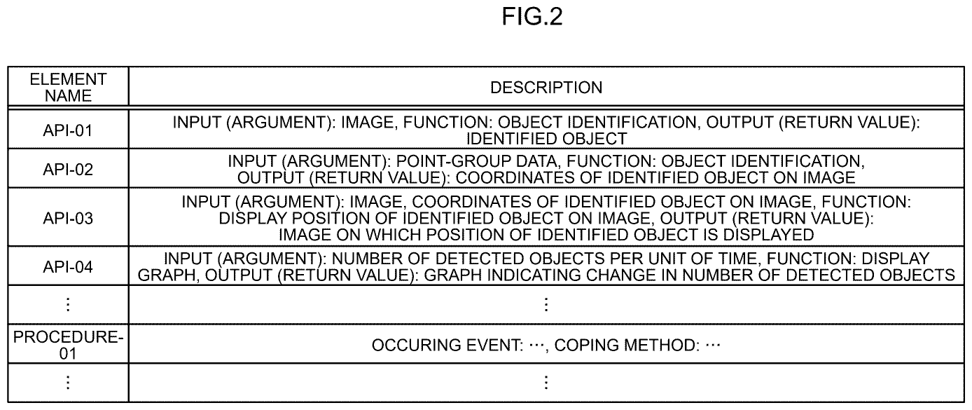

FIG. 2 illustrates exemplary element information that the storage unit 121 stores. Element information includes an element name and a description. The element name corresponds to information for identifying an element. The description indicates the description of the corresponding element.

An element having its element name including “API” is an example of the above-described API information. For example, “API-01” indicates an API that inputs an image to identify an object in the image. “API-02” indicates an API that inputs point-group data to identify an object in the point-group data. “API-03” indicates an API that inputs an image and an object identified from the image to display an image of the object. “API-04” indicates an API that inputs the number of detected objects per unit of time to display a graph indicating a change in the number of detected objects.

An element having its element name including “procedure” is an example of the above-described procedure information. For example, the element “procedure-01” has its description in which an occurring event and a method of response at the time of occurrence of the event are associated with each other.

Note that, as the storage unit 121, any generally available storage medium, such as a flash memory, a memory card, a random access memory (RAM), a hard disk drive (HDD), or an optical disc, can be provided.

Referring back to FIG. 1, further description will be given. The display unit 122 corresponds to a display device, such as a liquid crystal display, that displays various types of information.

The request acquisition unit 101 acquires a generation request described in natural language. The generation request corresponds to a request for generation of an execution procedure for at least one process. The generation request may be in any form. For example, text data or sound data is input as the generation request.

A method of acquiring information by the request acquisition unit 101 may be any method. For example, a method of acquiring information input through an interactive user interface, a method of receiving information from an external apparatus through a network, or a method of reading information from a storage medium can be employed.

As the generation request, a request achievable with a combination of at least one piece of element information in the element information stored in the storage unit 121 is assumed to be input. In a case where the element information is API information, for example, the generation request corresponds to a request for a new system achievable with a combination of software components or a combination of hardware components. In a case where the element information is procedure information, the generation request corresponds to a request for a coping procedure at the time of an incident or a request for creation of a new procedure.

The retrieval unit 102 retrieves at least one element for achieving the generation request from the elements indicated by the element information stored in the storage unit 121. A method of retrieving an element by the retrieval unit 102 may be any method. For example, any of the following methods can be used.
(M1) A language model is requested to perform retrieving an element candidate for achieving an execution procedure required to be generated by the generation request.
(M2) Element information with a high degree of similarity to a keyword included in the generation request is retrieved from the element information stored in the storage unit 121.
(M3) Element information having a feature quantity with a high degree of similarity to a feature quantity (e.g., a feature vector) of the generation request is retrieved from the element information stored in the storage unit 121. For example, the feature quantity can be calculated using a previously trained model (e.g., a neural network model).

Note that the retrieval unit 102 may be omitted. For example, in a case where all the pieces of element information stored in the storage unit 121 are set as candidates, the retrieval unit 102 is not necessarily provided.

Using at least one verification item CA (first verification item) determined in advance and the generation request, the verification-item generation unit 103 generates at least one verification item CB (second verification item) other than the verification item CA. A verification item corresponds to an item for verifying reference information for reference in generating an execution procedure.

The verification item CA corresponds to, for example, an item assumed to require commonly verifying to various execution procedures or an item minimum necessary for generation of an execution procedure. In a case where pieces of API information are combined to construct (generate) a new system, for example, an input, a function, an output for the system to be generated are determined as the verification item CA. In a case where procedure information on a manual for a product is generated, for example, the model number of the product is determined as the verification item CA.

The verification-item generation unit 103 may generate the verification item CB further using an element (element information) in addition to the verification item CA and the generation request. The element information may be element information retrieved by the retrieval unit 102. A method of generating a verification item by the verification-item generation unit 103 will be described in detail later.

From the pieces of reference information to be verified based on the verification item CA and the verification item CB, the identifying unit 104 identifies at least one piece of missing information indicating a piece of reference information that fails to be obtained from the generation request. For specification of such missing information, a technique, such as slot filling by which slots are made filled, can be used. For example, the identifying unit 104 gives the generation request and verification items (slots) to a language model. In addition, in a case where the generation request includes reference information corresponding to a verification item, the identifying unit 104 instructs the language model to fill the verification item with the reference information. The identifying unit 104 can identify, as missing information, reference information to be verified based on an unfilled verification item.

The information acquisition unit 105 acquires the identified missing information from an information source other than the generation request. For example, the information acquisition unit 105 acquires the missing information with at least either of the following acquisition methods.
(A1) A method of acquiring the missing information input in response to a request for inputting the identified missing information.
(A2) A method of acquiring the mission information from an apparatus outside the information processing apparatus 100.

In response to the generation request, the procedure generation unit 106 generates an execution procedure to be generated. For example, using the generation request, the missing information acquired by the information acquisition unit 105, and the element information, the procedure generation unit 106 combines at least one piece of element information to generate an execution procedure for fulfilling the generation request.

Using the generation request, the reference information obtained from the generation request, and the acquired missing information, the procedure generation unit 106 first selects at least one element from the elements indicated by the element information. The procedure generation unit 106 generates an execution procedure, based on the at least one selected element. For example, for generation of an execution procedure, the procedure generation unit 106 requests the language model to generate the execution procedure based on the selected element.

The procedure generation unit 106 may classify (arrange) the reference information (including the acquired missing information) into types and then generate an execution procedure using the reference information and the classified missing information. The types indicate at least indicate that the reference information or missing information correspond to which of the input for the execution procedure, the output for the execution procedure, and the function for the execution procedure. A method of classifying the reference information will be described in detail later.

The output control unit 111 controls output of various types of information for use in the information processing apparatus 100. For example, the output control unit 111 outputs information indicating the classified reference information or missing information of each type. A method of outputting the information may be any method. For example, a method of displaying the information on a display device, such as the display unit 122, or a method of transmitting the information to an external apparatus through a network can be employed.

At least any of the above-described units (the request acquisition unit 101, the retrieval unit 102, the verification-item generation unit 103, the identifying unit 104, the information acquisition unit 105, the procedure generation unit 106, and the output control unit 111) may be achieved by at least one processor. For example, the above-described units are each achieved by one or a plurality of processors. For example, the above-described units may be each achieved by causing a processor, such as a central processing unit (CPU) or a graphics processing unit (GPU), to execute a program, namely, by software. The above-described units may be each achieved by a processor such as a dedicated integrated circuit (IC), namely, by hardware. The above-described units may be each achieved by software and hardware in combination. In a case where a plurality of processors is used, each processor may achieve any one of the units or any two or more of the units.

The information processing apparatus 100 may be physically formed of a single apparatus or may be physically formed of a plurality of apparatuses. For example, the information processing apparatus 100 may be constructed on a cloud environment. The units in the information processing apparatus 100 may be provided to a plurality of apparatuses in a distribution manner.

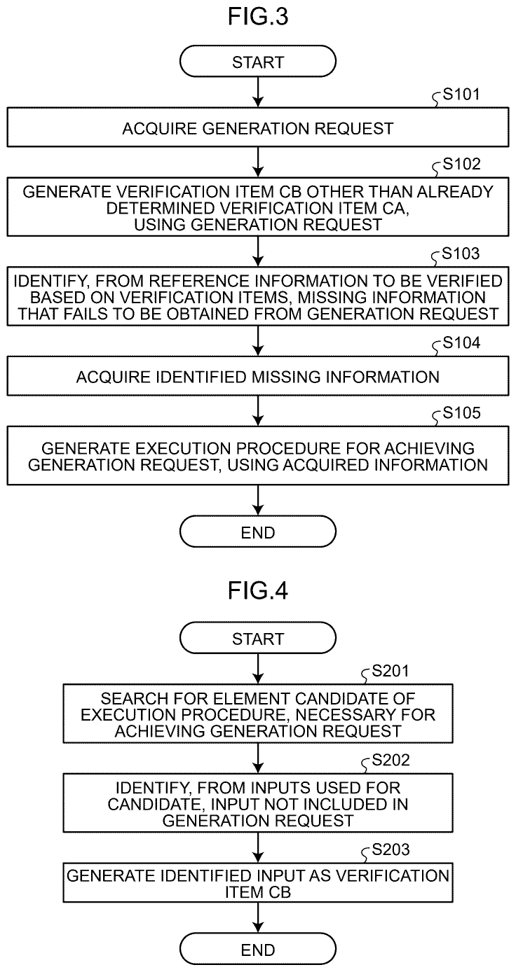

Next, a procedure generation process by the information processing apparatus 100 according to the embodiment will be described. FIG. 3 is a flowchart illustrating an exemplary procedure generation process in the embodiment.

The request acquisition unit 101 acquires a generation request input by a user, for example (Step S101). Using the generation request, the verification-item generation unit 103 generates the verification item CB other than the already determined verification item CA (Step S102). As described above, for example, using the element information retrieved by the retrieval unit 102, the verification-item generation unit 103 may generate the verification item CB.

The identifying unit 104 identifies, from the reference information to be verified based on the verification items (verification items CA and CB), missing information that fails to be obtained from the generation request, (Step S103). The information acquisition unit 105 acquires the identified mission information (Step S104).

Using the acquired information, the procedure generation unit 106 generates an execution procedure for achieving the generation request (Step S105). For example, using the generation request, the missing information acquired in Step S104, and the element information, the procedure generation unit 106 combines at least one piece of element information to generate an execution procedure.

Next, a method of generating the verification item CB by the verification-item generation unit 103 (Step S102) will be described in detail. For example, the verification-item generation unit 103 generates a part or all of the following three verification items CB1 to CB3 or all thereof.
(CB1) A verification item to the input for an execution procedure (for an element for an execution procedure) in a case where the input is missing.
(CB2) A verification item necessary for identifying an element (element information) necessary for generation of an execution procedure.
(CB3) A verification item for embodying the generation request.

The verification item CB1 corresponds to a verification item for verifying the input for an element as reference information. For example, the verification-item generation unit 103 generates the verification item CB for verifying an input other than the input verified based on the verification item CA from at least one input for an element.

The verification item CB2 corresponds to a verification item for verifying, as reference information, an element necessary for generation of an execution procedure. For example, the verification-item generation unit 103 generates the verification item CB for verifying reference information indicating an element for use in generation of an execution procedure from at least one element.

The verification item CB3 corresponds to a verification item for verifying, as reference information, an expression that embodies an expression requiring embodying from expressions included in the generation request. For example, the verification-item generation unit 103 generates the verification item CB for verifying reference information indicating an expression that embodies an expression requiring embodying from at least one expression included in the generation request.

Respective methods of generating the three verification items CB1 to CB3 will be described below. First, a method of generating the verification item CB1 will be described. FIG. 4 is a flowchart illustrating an exemplary verification-item generation process in the embodiment. FIG. 4 corresponds to an exemplary method of generating the verification item CB1.

For example, the retrieval unit 102 retrieves an element candidate necessary for achieving the generation request (Step S201). In a case where an element is assumed to be an API for software components, the verification-item generation unit 103 identifies, from inputs (arguments) for the API, an input missing in the generation request (input not included in the generation request) (Step S202). The verification-item generation unit 103 generates the identified input as the verification item CB (Step S203).

As a method of finding an input that fails to be obtained from the generation request from inputs for the API, for example, the following methods can be used:
A method using the function of function calling with a language model and the like.
A method in which a language model generates an execution procedure and then the generated execution procedure is analyzed in terms of argument to find a missing input.

In a case where a language model is used, the verification-item generation unit 103 may request the language model not only to generate a verification item but also to perform retrieval using the above-described method (M1). In other words, the verification-item generation unit 103 may request the language model to perform both retrieval of an element candidate and a process required to generate a verification item.

For the generation request to be achieved due to a combination of a plurality of elements (APIs), for example, the verification-item generation unit 103 may perform function calling to each of the plurality of elements to generate the verification item CB. The verification-item generation unit 103 may cause the language model to generate an execution procedure with the plurality of APIs to determine a missing argument.

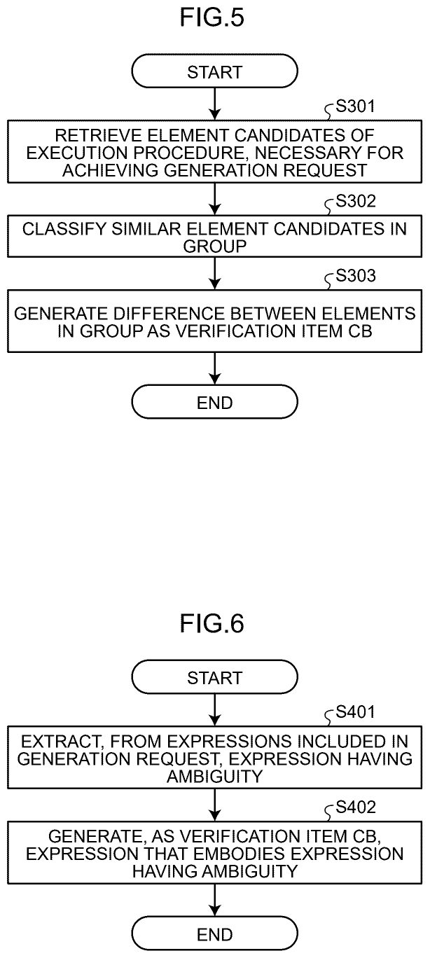

Next, a method of generating the verification item CB2 will be described. FIG. 5 is a flowchart illustrating another exemplary verification-item generation process in the embodiment. FIG. 5 corresponds to an exemplary method of generating the verification item CB2.

For example, the retrieval unit 102 retrieves element candidates necessary for achieving the generation request (Step S301). In a case where an element is assumed to be an API for software components, the verification-item generation unit 103 generates the verification item CB as to which of a plurality of elements (APIs) similar in function should be employed. For example, the verification-item generation unit 103 groups a plurality of elements (APIs) similar in function, together (Step S302). The verification-item generation unit 103 generates, as the verification item CB, the difference between the plurality of elements included in a group (Step S303). For example, using the language model, the verification-item generation unit 103 generates, as the verification item CB, a query for verifying the difference between the plurality of elements in a group.

Any method may be used for determination of similar functions. For example, a method of making a determination based on the degree of similarity in input, output, and function or a method of making a determination with reference to information on similar functions stored in advance in the storage unit 121 or the like can be employed.

Next, a method of generating the verification item CB3 will be described. FIG. 6 is a flowchart illustrating another exemplary verification-item generation process in the embodiment. FIG. 6 corresponds to an exemplary method of generating the verification item CB3.

For example, the verification-item generation unit 103 extracts an expression having ambiguity from expressions (e.g., words and phrases) included in the generation request (Step S401). Ambiguity that an expression has may be determined by any method. For example, the verification-item generation unit 103 may calculate a degree of frequency of an expression included in each of the generation request and an expression included in the description of an element stored in the storage unit 121 and determine ambiguity based on the degree of frequency. For example, in a case where an expression included in the generation request has a smaller degree of frequency than an expression included in the description of an element, the verification-item generation unit 103 extracts, as an expression having ambiguity, the expression included in the generation request. Using the language model, the verification-item generation unit 103 may determine ambiguity of an expression included in the generation request.

The verification-item generation unit 103 regards an ambiguous expression as an expression requiring embodying and generates the verification item CB for verifying an expression that embodies the expression (Step S402).

Next, methods of acquiring missing information (A1) and (A2) will be described in detail. (A1) corresponds to a method of requiring, in an interactive input manner, reference information to be verified based on a verification item or a method of presenting a list of verification items to require input of reference information. (A2) corresponds to a method of acquiring missing information using an external apparatus (system), such as a search engine.

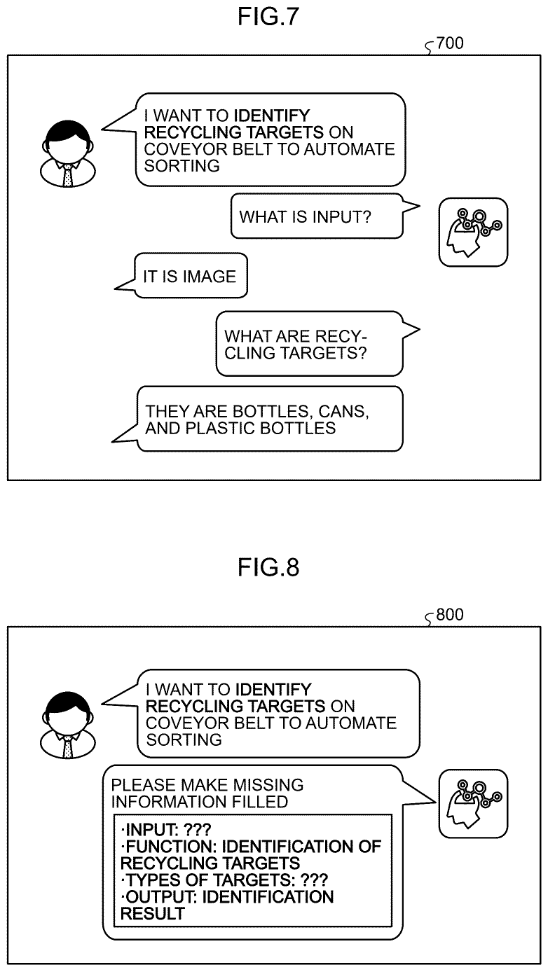

FIG. 7 illustrates an exemplary user interface that requires input of reference information in an interactive manner. An input screen 700 illustrated in FIG. 7 is an exemplary screen in a case where the generation request “I want to identify recycling targets on a conveyor belt to automate sorting” is acquired.

In response to such a generation request, for example, “API-01” in FIG. 2 as an API that inputs an image to identify an object in the image and “API-02” in FIG. 2 as an API that inputs point-group data to identify an object in the point-group data are retrieved as element candidates. For such an API, an input, a function, and an output are determined as the verification item CA. The generation request in FIG. 7 includes identification of recycling targets (object identification) as the function and an identification result (identified objects) as the output but includes no information for identifying whether the input is an image or point-group data. Thus, reference information indicating the input in the reference information to be verified based on the verification item CA is identified as missing information.

The information acquisition unit 105 acquires the identified missing information from an information source other than the generation request, namely, from information input into the interactive input screen 700. “What is the input?” in FIG. 7 corresponds to a query for acquiring this missing information (input). In response to this query, the user inputs information, such as “it is an image”.

Furthermore, in order to operate “API-01” and “API-02” properly, it is necessary to specify the types of the targets to be subjected to object identification. Since the generation request includes no types of the targets, the verification-item generation unit 103 generates the verification item CB in which no types of the targets are included in the generation request. For example, the verification-item generation unit 103 regards “recycling targets” included in the generation request as an ambiguous expression and generates the verification item CB for verifying an expression that embodies the expression. “What are the recycling targets?” in FIG. 7 corresponds to a query indicating reference information (missing information) to be verified based on the verification item CB. In response to this query, the user inputs reference information (the types of the targets) such as “they are bottles, cans, and plastic bottles”.

As above, in the present embodiment, in addition to the previously determined verification item CA (input, function, and output), the verification item CB other than the verification item CA is generated for verification of reference information for generation of an execution procedure. Thus, for generation of an execution procedure, missing information can be inhibited from occurring, leading to an improvement in the accuracy of task planning using the language model.

FIG. 8 illustrates an exemplary user interface that presents a list of verification items to require input of reference information. An input screen 800 illustrated in FIG. 8 is an exemplary screen that displays “? ??” representing missing information to prompt the user to input the missing information.

The information acquisition unit 105 may determine the order of acquisition of at least one piece of identified missing information (priority or ranking) and acquire the missing information in the determined order of acquisition. For example, in the order of acquisition, the information acquisition unit 105 acquires the missing information, using an external apparatus or an interactive input screen.

For example, the order of acquisition can be determined using a machine learning model (e.g., a neural network model) trained with learning data in which the order for missing information is defined. A method of determining the order of acquisition is not limited to this. For example, a method may be used in which a language mode receives missing information to output the order of acquisition.

When fails to acquire missing information, the information acquisition unit 105 may be configured not to acquire missing information later in the order of acquisition than the missing information having not been acquired.

For example, in a case where missing information is acquired in an interactive manner in the order of acquisition and then missing information fails to be obtained due to “I don't know” or “Nothing in particular” input by the user (in a case where a slot fails to be made filled), the information acquisition unit 105 stops acquiring information after the failure. Thus, an inquiry for any unimportant verification item can be eliminated.

Next, a method of classifying pieces of reference information and generation of an execution procedure using the classified pieces of reference information will be described in detail.

For example, the procedure generation unit 106 classifies pieces of reference information (including acquired missing information) into types. The types correspond, for example, an input for an execution procedure, an output for an execution procedure, and a function for an execution procedure. The types may include the type of reference information acquired based on the verification item CB. The procedure generation unit 106 may classify the pieces of reference information into types using the language model.

Using the generation request, the classified pieces of reference information (including missing information), and the element information, the procedure generation unit 106 combines at least one piece of element information to generate an execution procedure for fulfilling the generation request. For example, the procedure generation unit 106 inputs, into the language model, a request, including the generation request, the classified pieces of reference information (including missing information), and the element information, for generation of an execution procedure with the element indicated by the element information, causing the language model to generate the execution procedure.

For example, using the function of function calling of the language model or reasoning and acting (ReAct), the procedure generation unit 106 can cause the language model to generate an execution procedure.

As described above, the language model receives information including the classified (arranged) pieces of reference information for reference in generating an execution procedure. Thus, the input, output, and function for an execution procedure are clear, leading to an improvement in the accuracy of generation of an execution procedure.

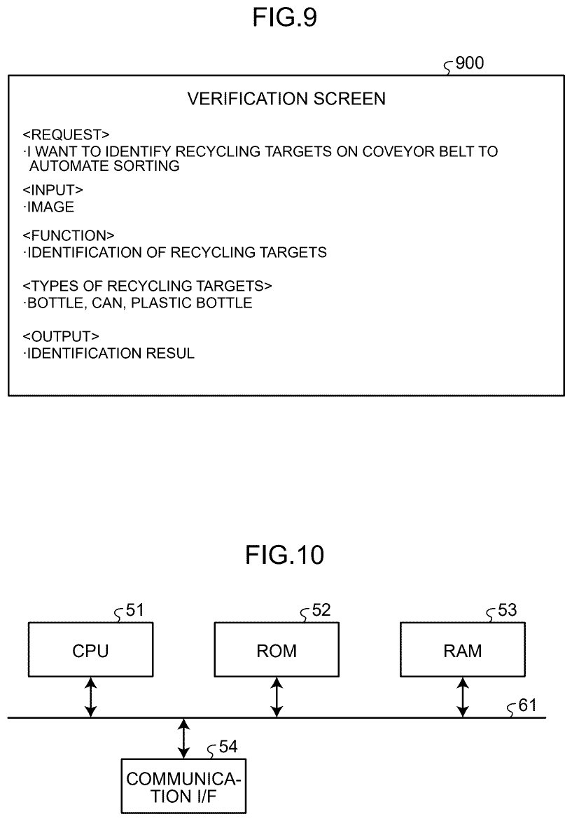

The output control unit 111 may output information indicating the classified pieces of reference information. FIG. 9 illustrates, as an example, a verification screen 900 for verifying the classified pieces of reference information. On the verification screen 900, the reference information classified into four types of “input”, “function”, “types of targets”, and “output” are output together with the generation request input by the user or the like. On the verification screen 900, the user can verify information to be given to the language model.

The procedure generation unit 106 may verify whether the execution procedure generated by the language model is valid. In a case where the execution procedure is not valid, the procedure generation unit 106 may request the language model to generate an execution procedure, again. For example, the procedure generation unit 106 verifies whether the input and output in the generated execution procedure agree with the requested input and output, respectively. In a case where either the input or the output has a disagreement or the input and the output each have a disagreement, the procedure generation unit 106 feeds back information indicating disagreement to the language model to cause the language model to generate an execution procedure, again. Thus, an execution procedure closer to the generation request can be generated.

As above, the information processing apparatus according to the embodiment enables an improvement in the accuracy of task planning using the language model.

Next, the hardware configuration of the information processing apparatus according to the embodiment will be described with FIG. 10. FIG. 10 is an explanatory diagram illustrating an exemplary hardware configuration of the information processing apparatus according to the embodiment.

The information processing apparatus according to the embodiment includes a control device, such as a central processing unit (CPU) 51, storage devices, such as a read only memory (ROM) 52 and a random access memory (RAM) 53, a communication I/F 54 that establishes connection with a network to perform communication, and a bus 61 through which the constituents are connected.

A program to be executed in the information processing apparatus according to the embodiment is installed in advance on the ROM 52 or the like for provision.

The program to be executed in the information processing apparatus according to the embodiment may be recorded, in an installable file format or in an executable file format, on a computer-readable recording medium, such as a compact disk read only memory (CD-ROM), a flexible disk (FD), a compact disk recordable (CD-R), or a digital versatile disk (DVD), for provision as a computer program product.

Furthermore, the program to be executed in the information processing apparatus according to the embodiment may be stored in a computer connected to a network, such as the Internet, and may be downloaded through the network for provision. The program to be executed in the information processing apparatus according to the embodiment may be provided or distributed through a network, such as the Internet.

The program to be executed in the information processing apparatus according to the embodiment can cause a computer to function as each unit in the above-described information processing apparatus. Regarding the computer, the CPU 51 is capable of loading the program from a computer-readable recording medium onto a main storage device and executing the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computer program product comprising a non-transitory computer-readable medium including programmed instructions, the instructions causing a computer to perform:
acquiring a generation request for generation of an execution procedure for at least one process, the generation request being described in natural language;
using the generation request and at least one first verification item determined in advance, generating at least one second verification item, the at least one first verification item serving as a verification item for verifying reference information for reference in generating the execution procedure, the at least one second verification item being the verification item other than the at least one first verification item;
identifying at least one piece of missing information indicating the reference information not obtained from the generation request, in the reference information to be verified based on the at least one first verification item and the at least one second verification item;
acquiring the at least one piece of identified missing information, from an information source other than the generation request; and
selecting, from at least one element determined in advance for the execution procedure, at least one element using the generation request, the reference information obtained from the generation request, and the at least one piece of acquired missing information, and generating the execution procedure based on the at least one selected element.

2. The product according to claim 1, wherein
the generating at least one second verification item includes generating the at least one second verification item using the at least one first verification item, the generation request, and the at least one element.

3. The product according to claim 2, wherein
the instructions causes the computer to further perform retrieving, from the at least one element, at least one element for achieving the execution procedure, and
the generating at least one second verification item includes generating the at least one second verification item using the at least one first verification item, the generation request, and the at least one retrieved element.

4. The product according to claim 1, wherein
the reference information includes at least one input for the at least one element, and
the generating at least one second verification item includes generating the at least one second verification item for verifying the input other than the input to be verified based on the at least one first verification item from the at least one input.

5. The product according to claim 1, wherein
the generating at least one second verification item includes generating the at least one second verification item for verifying the reference information indicating the at least one element used for generation of the execution procedure among the at least one element.

6. The product according to claim 1, wherein
the generating at least one second verification item includes generating the at least one second verification item for verifying the reference information that embodies at least one expression that is included in the generation request and requires embodying.

7. The product according to claim 1, wherein
the acquiring the at least one piece of identified missing information includes acquiring the at least one piece of missing information by at least one of a method of acquiring the at least one piece of missing information input in response to an input request for the at least one piece of identified missing information and a method of acquiring the at least one piece of missing information from an apparatus outside the computer.

8. The product according to claim 1, wherein
the acquiring the at least one piece of identified missing information includes determining an order of acquisition of the at least one piece of identified missing information and acquiring the at least one piece of missing information in the determined order of acquisition.

9. The product according to claim 8, wherein
the acquiring the at least one piece of identified missing information includes ceasing, in a case where the at least one piece of missing information fails to be acquired, acquiring the at least one piece of missing information later in the order of acquisition than the at least one piece of missing information having not been acquired.

10. The product according to claim 1, wherein
the generating the execution procedure includes classifying the reference information and the at least one piece of missing information into types and generating the execution procedure using the reference information and the at least one piece of missing information that are classified.

11. The product according to claim 10, wherein
the types at least indicate that the reference information and the type of the at least one piece of missing information correspond to which of an input of the execution procedure, an output of the execution procedure, or a function of the execution procedure.

12. The product according to claim 10, wherein
the instructions cause the computer to further perform outputting information indicating the reference information and the at least one piece of missing information classified into the types.

13. An information processing apparatus comprising:
one or more processors configured to:
acquire a generation request for generation of an execution procedure for at least one process, the generation request being described in natural language;
generate, using the generation request and at least one first verification item determined in advance, at least one second verification item, the at least one first verification item serving as a verification item for verifying reference information for reference in generating the execution procedure, the at least one second verification item being the verification item other than the at least one first verification item;
identify at least one piece of missing information indicating the reference information not obtained from the generation request, in the reference information to be verified based on the at least one first verification item and the at least one second verification item;
acquire the at least one piece of identified missing information, from an information source other than the generation request; and
select, from at least one element determined in advance for the execution procedure, at least one element using the generation request, the reference information obtained from the generation request, and the at least one piece of acquired missing information, and generate the execution procedure based on the at least one selected element.

14. An information processing method to be performed by an information processing apparatus, the information processing method comprising:
acquiring a generation request for generation of an execution procedure for at least one process, the generation request being described in natural language;
using the generation request and at least one first verification item determined in advance, generating at least one second verification item, the at least one first verification item serving as a verification item for verifying reference information for reference in generating the execution procedure, the at least one second verification item being the verification item other than the at least one first verification item;
identifying at least one piece of missing information indicating the reference information not obtained from the generation request, in the reference information to be verified based on the at least one first verification item and the at least one second verification item;
acquiring the at least one piece of identified missing information, from an information source other than the generation request; and
selecting, from at least one element determined in advance for the execution procedure, at least one element using the generation request, the reference information obtained from the generation request, and the at least one piece of acquired missing information, and generating the execution procedure based on the at least one selected element.
